(19) United States
(12) Patent Application Publication
(10) Pub. No.: US 2003/0081294 A1
(43) Pub. Date: May 1, 2003

(54) Free-space optical WDM communication system

(76) Inventor: Jae-Seung Lee, Seoul (KR)

Correspondence Address: David Tichane, 979 Pinto Palm Terrace, #24, Sunnyvale, CA, 94087, US

(21) Appl. No.: 10/259,162

(22) Filed: Sep. 26, 2002

Related U.S. Application Data
(63) Continuation of application No. PCT/KR01/00388, filed on Mar. 13, 2001.

(30) Foreign Application Priority Data
Mar. 27, 2000 (KR) 2000-15646

(51) Int. Cl. H04J 14/02; H04B 10/00

(52) U.S. Cl. 359/172; 359/124

(57) ABSTRACT

The present invention provides a free-space optical WDM communication system that couples received channels into an optical fiber to use optical amplifier at the receiver and thereby to increase the transmission distance. The transmitted and received channels are coupled into a free-space and a fiber, respectively, using the same light beam emitting and focusing (LBEF) unit that consists of focusing optical assemblies, beam-to-fiber coupler, and a fiber coupler. The LBEF unit is connected to both transmitter and receiver circuits using an optical circulator or a WDM coupler. The invention includes the use of an amplified spontaneous emission and also provides a free-space optical repeater that amplifies or regenerates free-space WDM channels with an add-drop multiplexing capability during propagation.

### CROSS-REFERENCE TO THE RELATED APPLICATIONS

This Application is a continuation of International Application No. PCT/KR01/00388, whose International filing date is Mar. 13, 2001 and priority date is Mar. 27, 2000, the disclosures of which Application are incorporated by reference herein. The PCT application was published on Oct. 4, 2001 WO 01/73979 A1. This application is related to Republic of Korea Patent Application No. 2000-15646 filed on Mar. 27, 2000, whose priority is claimed under 35 USC. sctn.119, the disclosure of which is incorporated by reference in its entirety.

### BACKGROUND OF THE INVENTION

1. Field of the Invention

The present invention relates to free-space optical communication systems in which light is directly transmitted and received through the air.

2. Description of the Related Art

In order to achieve wavelength division multiplexing (WDM) optical communication through various networks, free-space optical communication schemes that transmit and receive light directly through free-space are needed in some areas without cabling optical fibers for which high cost may be required to install. Conventional free-space optical communication systems are heavily affected by atmospheric instabilities and meteorological irregularities. Moreover, they have difficulty in utilizing optical amplifiers because a single mode optical fiber element is not used at the receiving terminal.

Until now, free-space optical communications do not couple the received light with a conventional single mode optical fiber. Therefore, various WDM elements and optical pre-amplifiers having single mode optical fibers for input/output terminals cannot be used for the receiving terminal, which make it difficult to compensate for transmission loss. As a result, the optical output power of a transmission terminal should be high enough to fully compensate for high atmospheric losses due to meteorological conditions for about several-kilometer free-space transmission, and hence, free-space optical communication systems are not popular. Moreover, the method has not been intended to aggregate optical transmitting and receiving apparatuses using an optical circulator comprising optical fiber input/output terminals.

D. R. Wisely et al. used a single optical channel for the free-space optical transmission where a photodetector was used directly next to the optical focusing unit at the receiving terminal instead of the optical fiber (D. R. Wisely, M. J. McCullagh, P. L. Eardley, P. P. Smyth, D. Luthra, E. C. De Miranda, and R. Cole. “4 km terrestrial line-of-sight optical free-space link operating at 155 Mbit/s”, SPIE, vol 2123. pp. 108-119, 1996). This scheme has a problem when the bit rate reaches more than several Gb/s because the area of the photodetector should be reduced in proportion to the bit rate thus increasing the light coupling loss significantly.

G. Nykolak et al. introduced a free-space optical WDM communication scheme using multi-mode optical fiber elements. (G. Nykolak, P. F. Szajowski, J. Jaxques, H. M. Presby. J. A. Abate, G. E. Tourgee, and J. J. Aubrn, “4×2.5 Gb/s 4.4 km WDM free-space optical link at 1550 nm”, in Proc. OFC '99, paper PD11. 1999). Although the details are not provided, it is believed that the beam-to-fiber coupler such as fiber-pigtailed GRIN (graded index) lens next to the optical focusing unit at the receiving terminal is not used, but multi-mode optical fiber is directly used instead. Channel spacings of multi-mode optical fiber elements are wider than that of single mode elements, and the optical pre-amplifier does not fit well with the multimode fiber.

I. I. Kim et al. used single channel, however, the signal wavelength is where the conventional optical amplifier is unavailable. Also, they did not use any optical fiber elements at the receiving terminal (I. I Kim, E. J. Korevaar, H. Hakaha, R. Stieger, B. Riley, M. Mitchell, N. M. Wong, A. Lath. C. Mourwund, M. Barclay, J. J. Schuster, AstroTerra Corp, “Horizontal-link performance of the STRV-2 lasercom experiment ground terminals,” SPIE, vol. 3615, pp. 11-22, 1999). Moreover, the following methods intended in the present patent application for stable transmission of optical signals have not been attempted:

The method in which several optical focusing units are provided so that the effects of fluctuating light path within the air can be reduced.

The method in which optical pre-amplifier is used in each of WDM optical channels at the receiving terminal.

The method in which the optical repeater that amplifies or regenerates optical signal during the propagation is used.

The method in which spectrum-sliced amplified-spontaneous emission is used as a light source so that the noise of the optical signal intensity can be reduced in the application of the current free-space optical communication.

### SUMMARY OF THE INVENTION

Thus, the objective of the present invention is to provide more stabilized large-scale WDM optical communication by making up for the abovementioned problems for free-space optical communication systems.

The present invention adopts a beam-to-fiber coupler next to the optical focusing unit and couples received optical signals into a single mode optical fiber or a multi-mode optical fiber to enhance the optical coupling efficiency. In particular, an optical pre-amplifier is more accessible when the single mode optical fiber is employed.

### BRIEF DESCRIPTION OF THE DRAWINGS

FIG. 1 illustrates a schematic diagram of a free-space optical WDM communication system.

FIG. 2 illustrates a schematic diagram of a single channel free-space optical communication system.

FIG. 3 illustrates a schematic diagram of a light beam emitting and focusing unit for a plurality of optical WDM channels.

FIG. 4 illustrates a schematic diagram of a light beam emitting and focusing unit for a single optical channel.

FIG. 5 illustrates a schematic diagram of a free-space optical repeater.

FIG. 6 illustrates a schematic diagram of a bidirectional free-space optical repeater.

FIG. 7 illustrates a schematic diagram of a receiving section of a WDM free-space optical system.

FIG. 8 illustrates a schematic diagram of a receiving section of a single channel free-space optical system.

### DETAILED DESCRIPTION OF THE INVENTION

The present invention relates a free-space optical WDM communication system comprising novel schemes to reduce transmission losses and enhance the quality of the transmitted signal compared with conventional free-space optical communication systems. The technical problems solved by the present invention are as follows:

1. A single light beam emitting and focusing unit may be shared for both the transmission and the reception using a WDM fiber coupler or an optical circulator having fiber input/output terminals.

2. When the optical WDM channels are received using a light beam emitting and focusing unit, a beam-to-fiber coupler is used to collect the received channels into an optical fiber. Thus, optical amplifiers and wavelength division demultiplexers can be used at the receiving terminal and the intensity of the light from a transmission terminal can be reduced to more than 10 dB.

3. At least one optical focusing unit is provided to the light beam emitting and focusing unit in order to minimize the effects from such as beam scintillation due to irregular atmospheric perturbations and high transmission losses that cause problems in free-space optical communications.

4. The free-space optical repeater is employed in order to compensate for the loss of transmitted optical signal during the propagation in free-space.

5. An optical pre-amplifier may be provided for each channel next to the wavelength division demultiplexer to minimize the optical gain fluctuation owing to the random change of received channel powers of other neighboring channels.

6. Scintillation problems that cause the transmitted channel power to change irregularly owing to random atmospheric perturbations may be settled using amplified-spontaneous emission or spectrum-sliced amplified-spontaneous emission as a signal light.

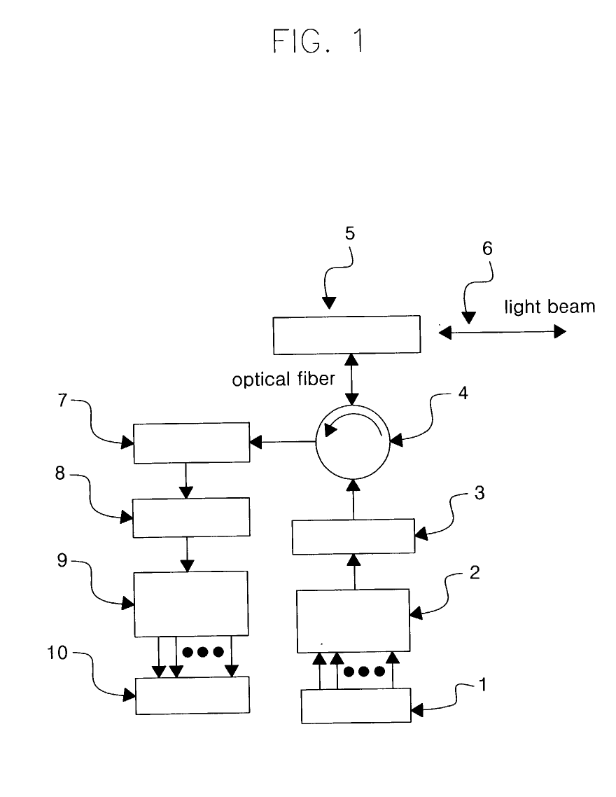

FIG. 1 illustrates a schematic diagram of a free-space optical WDM communication system. In a light source section 1, where at least one channel is present, light channels having different center wavelengths are modulated. Although a laser diode can be used as a light source, its phase front is not constantly held during the propagation but irregularly changed owing to the irregular refractive index change of the atmosphere. As a result, transmitted light channels are coupled into the optical fiber at the receiving terminal with large scintillation effects that causes the received power to fluctuate irregularly owing to the path difference interference. Accordingly, if the amplified-spontaneous emission, obtained e.g. from an optical amplifier without input signal, is modulated after the spectrum-slicing, it will have a similar or better communication quality than that of laser because the amplified-spontaneous emission has a wide light bandwidth so that the effect of path difference interference is rather weak.

The abovementioned WDM channels are merged into one optical fiber through a WDM multiplexer 2 after the modulation. Then, WDM optical channels are amplified by the optical booster amplifier 3 and sent to the optical circulator 4, and then, transmitted into the free-space with their beam 6 diameter extended by the light beam emitting and focusing unit 5. At the same time, optical channels received in the reverse direction are also coupled into the optical fiber through the same light beam emitting and focusing unit 5.

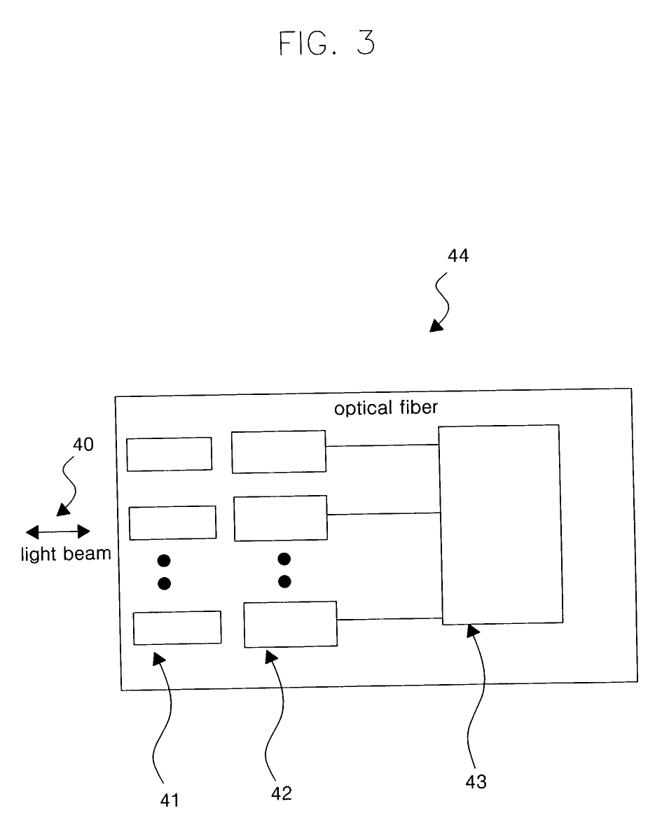

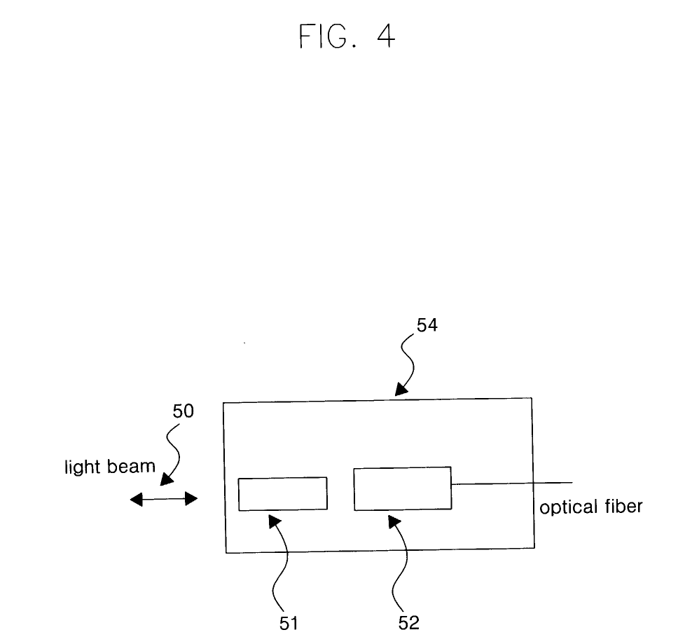

The light beam emitting and focusing unit 5 having a configuration shown in FIGS. 3 and 4, is an apparatus that couples the transmitted light into the optical fiber wherein the optical focusing unit 41, 51, having a configuration of Newtonian telescope or Schmidt Cassegrain telescope e.g., focuses the received light to the beam-to-fiber coupler 42, 52. In the reverse direction, the light beam emitting and focusing unit 5 serves to emit optical signal from the optical fiber into the free-space. This scheme enables the optical pre-amplifier 8 or 28 and the wavelength division demultiplexer 9 to be used in free-space optical transmission systems as well as in optical fiber communication systems. Thus, this scheme helps to compensate for the transmission loss and to reduce the channel spacing in frequency domain. In addition, the coupling efficiency of the beam-to-fiber coupler 42, 52 to couple the received light into the optical fiber is somewhat insensitive to the scintillation. The number of the optical focusing unit 41 within the light beam emitting and focusing unit 44 are larger than one as is shown in FIG. 3 in order to reduce the change of the received power owing to the scintillation of the transmitted beam. In this case, the fiber coupler 43 is needed to couple the same number of multiple beam-to-fiber coupler 42 outputs into a single fiber. The beam-to-fiber coupler 42 may employ a fiber-pigtailed GRIN (graded index) lens or an optical fiber having its core diameter enlarged near the fiber end by tapering.

Referring to FIG. 1, the received optical signals coupled into the optical fiber are passed through an optical circulator 4 and sent to an optical filter 7 which prevents the high power optical signals to be transmitted from entering into the receiver side owing to the reflection from the light beam emitting and focusing unit 5. The received optical signal after the optical filter 7 is amplified by the optical pre-amplifier 8, and then, after going through the wavelength-division demultiplexer 9, detected at the light detection section 10.

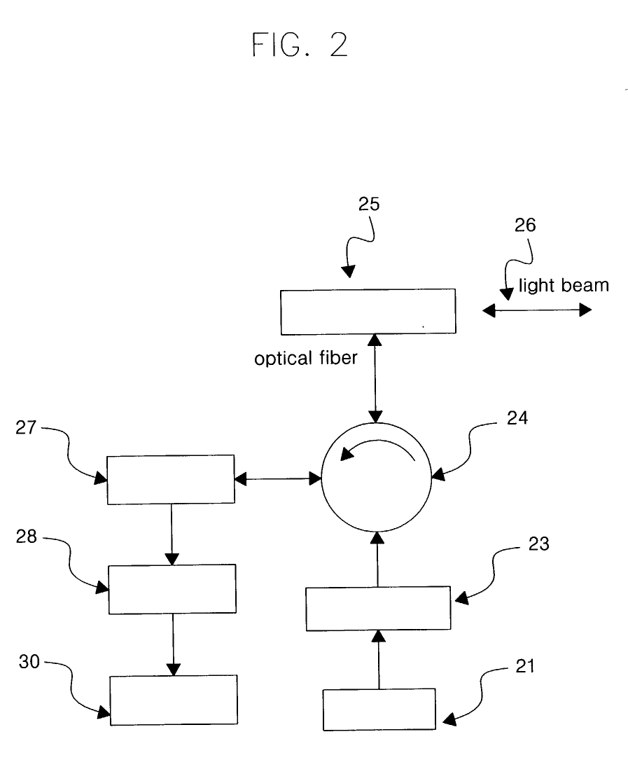

Multiple number of optical pre-amplifiers 8 may be used for each channel next to the wavelength division demultiplexor 9, which prevents the whole inter-channel gain characteristics from being unstable owing to the fluctuation of the received channel power that influences the gain process of neighboring channels. Moreover, gain properties may be more stabilized when the optical pre-amplifiers 8 are operated in a saturation mode. For a single optical channel case as is shown in FIG. 2, the wavelength division multiplexer 2 and the wavelength division demultiplexer 9 may be omitted compared with FIG. 1. The optical preamplifier 28 includes an optical filter to reduce the effects of the amplified-spontaneous emission.

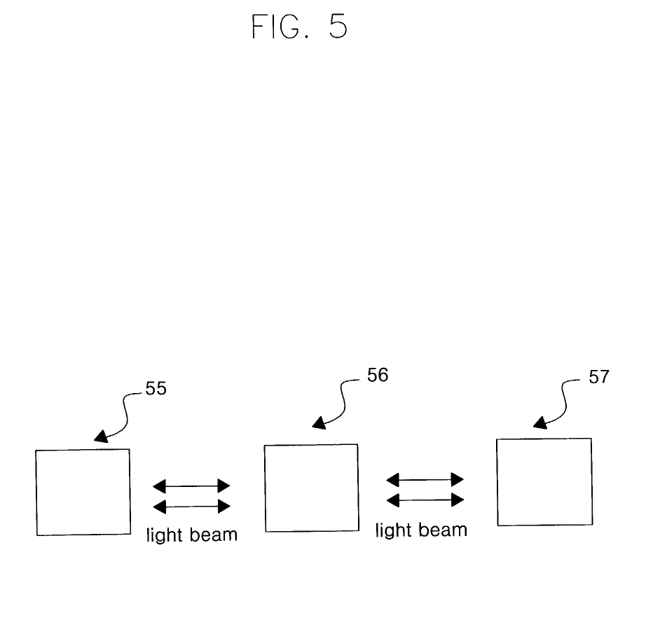

At least one free-space optical repeater 56 may be used in the intermediate position of the transmission path to prevent the light loss from growing too large during the propagation. FIG. 5 illustrates the case when a single free-space optical repeater 56 is used, in which the transmitted optical signal is amplified or regenerated using a free-space optical repeater 56 in the intermediated site of the free-space optical transmission path between arbitrary two communication nodes, node-1 55 and node-2 57. The free-space optical repeater 56 may amplify through optical signals using an optical amplifier, and further, it may regenerate the through optical signals using an electrical signal processing circuit, just like the regenerator in conventional optical fiber communication systems.

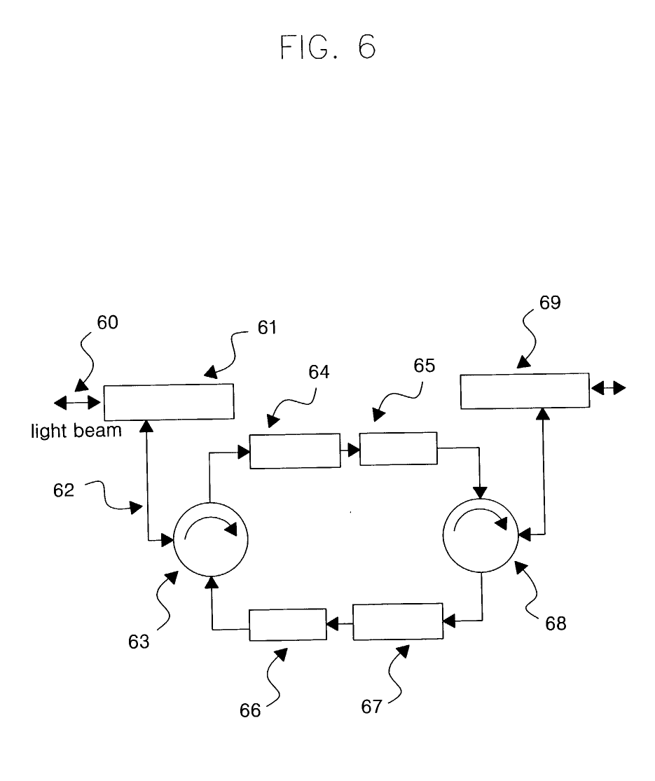

FIG. 6 illustrates a possible configuration of a bi-directional free-space optical repeater located at an intermediate point of the transmission path between two free-space optical communication nodes. The bidirectional free-space optical repeater uses the light beam emitting and focusing unit 61, 69 in FIG. 1 or 2 to couple the optical channels into an optical fiber on the way of transmission and to emit the amplified optical channel back into the free-space. The optical signal coupled into the optical fiber through the left light beam emitting and focusing unit 61 passes the optical circulator 63 and the optical filter 64, which removes the reflected lights from the light beam emitting and focusing unit 61. Then, the optical signal is amplified at the optical amplifier 65 and is sent to the optical circulator 68 and the other light beam emitting and focusing unit 69 to be emitted back into the free-space. This procedure is carried out symmetrically in both directions. Thus, the optical signal coupled into the optical fiber through the right light beam emitting and focusing unit 69 passes the optical circulator 68 and the optical filter 67, which removes the reflected lights from the light beam emitting and focusing unit 69. Then, the optical signal is amplified at the optical amplifier 66 and is sent to the optical circulator 63 and the other light beam emitting and focusing unit 61 to be emitted back into the free-space.

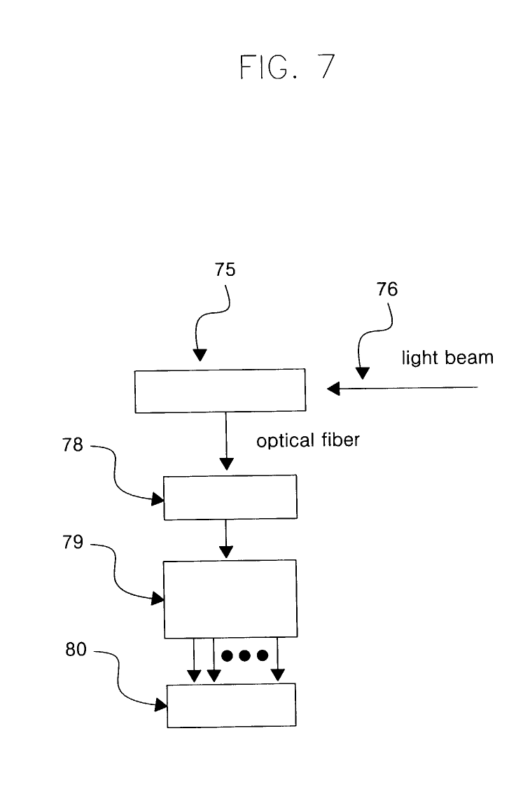

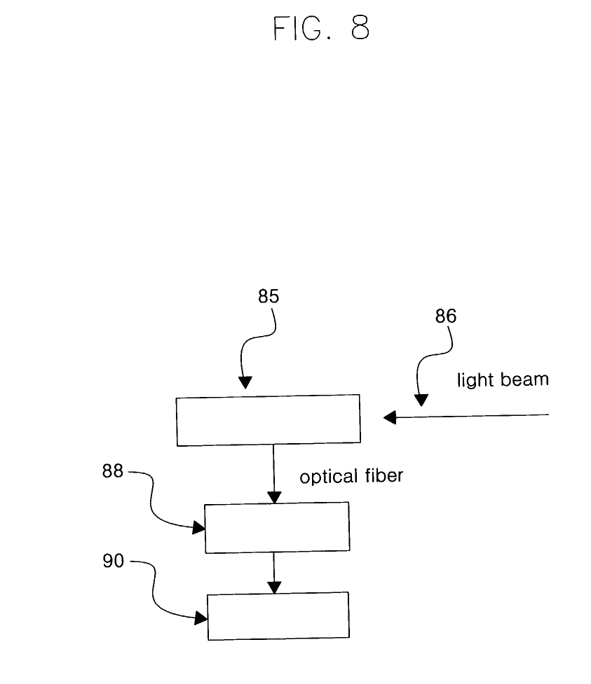

FIGS. 7 and 8 illustrate the case when the light beam emitting and focusing unit in FIGS. 1 and 2 are used only for the receiving purpose, in which the received optical signal coupled into an optical fiber is amplified through the optical pre-amplifier 78, 88. After then, when there are multiple WDM channels, the signals are detected at the light detection section 80 after passing through the wavelength division demultiplexer 79. When only one channel is present, it is detected directly at the light detection section 90. In the former case, the light detection section 80 is to be provided with the same number of photodetectors as the channel number.

If the abovementioned free-space optical repeater is provided with the capability of dropping or adding the optical channels according to their wavelengths and is also provided with the capability of converting the channel wavelength to modify the remote node where the channel is to be dropped, the site of the free-space optical repeater may also be used as a communication node, and therefore, free-space optical WDM communication networks can be efficiently configured.

Optical circulators 4, 24, 63, and 68 may be replaced by less expensive 2×2 or 1×2 fiber couplers, however, the light loss due to the fiber coupler may increase in this case. WDM couplers that allocate different output terminals according to the input light's wavelength can solve the loss problem. If the WDM coupler has a high isolation capability, optical filters 7, 27, 64, and 67 may not be necessary, leading to additional cost reduction.

The present invention provides a new WDM free-space optical communication system and a method for reducing the transmission loss and for enhancing the transmitted signal quality compared with the conventional free-space optical communication systems. In contrast with the conventional systems, the present invention may employ single mode optical fiber at the receiving terminal, which implies that the optical pre-amplifier is available, high density free-space optical WDM communication is also possible with reduced channel frequency spacing. In addition, more stabilized and higher received power can be sustained by employing the amplified-spontaneous emission, plurality of light beam focusing units, channel-dedicated optical pre-amplifiers, and free-space optical repeaters. Moreover, the invention has the advantages of reducing the cost and the system size because a single light beam emitting and focusing unit is shared for both transmission and reception.

What is claimed is:

1. A free-space optical communication system using a light beam emitting and focusing unit comprising:
an optical focusing unit for focusing an optical signal beam incident to a free-space; and
a beam-to-fiber coupler for coupling output light of said optical focusing unit into an optical fiber.

2. The free-space optical communication system as claimed in claim 1, wherein fiber-pigtailed GRIN (graded index) lens is used as said beam-to-fiber coupler.

3. The free-space optical communication system as claimed in claim 1, wherein an optical fiber having its core diameter enlarged near a fiber end by tapering is used as said beam-to-fiber coupler.

4. The free-space optical communication system as claimed in claim 1,
wherein said light beam emitting and focusing unit comprises:
plural number of optical focusing units;
beam-to-fiber couplers whose number is equal to the number of said optical focusing units; and
an added fiber coupler for coupling outputs of said beam-to-fiber couplers into a single optical fiber.

5. The free-space optical communication system as claimed in claim 1, wherein amplified-spontaneous emission is used as a light source.

6. The free-space optical communication system as claimed in claim 1, wherein a spectrum-sliced amplified-spontaneous emission is used as a light source.

7. The free-space optical communication system as claimed in claim 1, further comprising a receiving terminal comprising:
a light beam emitting and focusing unit for focusing the optical signal transmitted as a beam into an optical fiber;
an optical pre-amplifier for amplifying output of said light beam emitting and focusing unit; and
a light detection section for optically detecting said optical pre-amplifier output.

8. The free-space optical communication system as claimed in claim 7,
wherein a wavelength division demultiplexer, which demultiplexes wavelength-division multiplexed output of the optical pre-amplifier channel by channel, is added at output of the optical pre-amplifier, and
the said wavelength division demultiplexer outputs are detected by the light detection section separately channel by channel.

9. The free-space optical communication system as claimed in claim 7, comprising:
a light source section for generating one modulated optical channel to be transmitted,
an optical booster amplifier for amplifying output of said light source section, and
an optical circulator for sending output of said optical booster amplifier to the light beam emitting and focusing unit disposed between light beam emitting and focusing unit and an optical filter, thereby transmitting and receiving a single optical channel.

10. The free-space optical communication system as claimed in claim 8,
comprising:
a light source section for generating several modulated optical channels to be transmitted with different center wavelengths;
an optical wavelength division multiplexer for coupling optical channels of said light source section into one optical fiber;
an optical booster amplifier for amplifying output of said wavelength division multiplexer; and
an optical circulator for sending output of said optical booster amplifier to the light beam emitting and focusing unit disposed between light beam emitting and focusing unit and optical filter, thereby transmitting and receiving wavelength-division-multiplexed optical channels.

11. The free-space optical communication system as claimed in claim 8,
further comprising a plurality of optical pre-amplifiers disposed next to the wavelength division demultiplexer for each channel.

12. The free-space optical communication system as claimed in claim 8,
further comprising a plurality of optical pre-amplifiers disposed next to the said wavelength division demultiplexer with the number of optical pre-amplifiers corresponding to the number of channels.

13. A free-space optical repeater, as an application of the said free-space optical communication system as claimed in claim 1, which amplifies or regenerates the optical signal during a transmission disposed along a transmission path between arbitrary two communication nodes communicating with each other using the optical beam.

14. The free-space optical repeater as claimed in claim 13 located at an intermediate site of the transmission path between two free-space optical communication systems, comprising:
a first light beam emitting and focusing unit for coupling transmitted optical channels into an optical fiber and for emitting amplified optical channels back into the free-space;
an optical circulator for sending optical fiber output of said light beam emitting and focusing unit to an optical filter and for sending the optical channels amplified by an optical amplifier to said light beam emitting and focusing unit;
an optical filter for removing the optical signal reflected from said light beam emitting and focusing unit;
an optical amplifier for amplifying output of said optical filter;
a second light beam emitting and focusing unit for coupling transmitted optical channels into an optical fiber and again for emitting the amplified optical channels back into the free-space;
an optical circulator for sending the optical fiber output of said first light beam emitting and focusing unit to an optical filter and for sending the optical channels amplified at an optical amplifier to said first light beam emitting and focusing unit;
an optical filter for removing the optical signal reflected from said first light beam emitting and focusing unit; and
an optical amplifier for amplifying output of said optical filter.

15. The free-space optical repeater as claimed in claim 13, wherein optical channels are dropped and added according to wavelengths.

16. The free-space optical repeater as claimed in claim 15, wherein a wavelength transformer is incorporated so that a drop node for each optical channel is changeable.

17. The free-space optical communication system as claimed in claim 9 or 10, wherein optical fiber coupler is used instead of said optical circulator.

18. The free-space optical repeater as claimed in claim 14, wherein optical coupler is used instead of said optical circulator.

19. The free-space optical communication system as claimed in claim 9 or 10, wherein WDM coupler is used instead of said optical circulator.

20. The free-space optical repeater as claimed in claim 14, wherein WDM coupler is used instead of said optical circulator.
